(19) United States
(12) Patent Application Publication
(10) Pub. No.: US 2009/0246505 A1
(43) Pub. Date: Oct. 1, 2009

(54) AUTOMOTIVE INTERIOR COMPONENT WITH CANTILEVERED SKIN PORTION AND METHOD OF MAKING THE SAME

(75) Inventors: Gregg S. Evans, Windsor (CA); Chris Barney, Sterling Heights, MI (US)

Correspondence Address: Dykema Gossett PLLC - Los Angeles, CA, 333 S. Grand Avenue, Suite 2100, Los Angeles, CA, 90071, US

(73) Assignee: Intertec Systems, LLC, Troy, MI (US)

(21) Appl. No.: 12/409,248

(22) Filed: Mar. 23, 2009

Related U.S. Application Data
(60) Provisional application No. 61/039,636, filed on Mar. 26, 2008.

(51) Int. Cl. B32B 3/26; B29C 44/06

(52) U.S. Cl. 428/316.6; 264/46.5

(57) ABSTRACT

The invention provides for a multi-layer automotive interior component and method of making the same. The multi-layer automotive interior component comprises a skin layer having an exterior portion and an underside portion, where the exterior portion is visible. The multi-layer automotive interior component further comprises a foam dam formed on the underside portion of the skin layer, a cantilevered skin portion extending from the foam dam, a substrate disposed opposite the underside portion of the skin layer, and a foam layer between the substrate and the underside portion of the skin layer. The foam layer is limited by the foam dam, and the foam layer is substantially uniform.

### CROSS-REFERENCE TO RELATED APPLICATION

This application claims the benefit of provisional patent application U.S. Ser. No. 61/039,636, filed Mar. 26, 2008, which is expressly incorporated herein by reference.

### BACKGROUND

a. Field of Invention

The invention relates generally to automotive interior components such as instrument panels, door trims, and center consoles, and, more particularly, to an automotive instrument panel with a foam dam for defining a cantilevered skin portion.

b. Description of Related Art

Automotive interior components are often produced in a variety of manufacturing sequences based on the assembly requirements set forth by a manufacturer and are also produced to a variety of specifications based on the quality and appearance expected by customers. Namely, customers expect the automotive interior components to be visually appealing. Visually appealing features may include indirect lighting and similar blind (not visible) details. Moreover, automotive manufacturing practices are more efficient with simple processes and nominal waste.

Automotive instrument panels, door trims, center consoles, and other automotive interior components typically include layers bonded together to give the appearance of a solid piece. Depending on the automotive interior component, layers of assorted materials such as foam layers, substrates, fabrics, and plastics may be bonded to produce quality components.

Known instrument panels may be composed of a skin layer and a substrate with a foam layer therebetween. The skin layer and the substrate may be positioned in a mold cavity, and the foam layer may be injected between the skin layer and the substrate such that the foam layer fixedly joins the skin layer and the substrate to each other. Known instrument panels include curves to fit the lines of an automotive vehicle interior and provide visual appeal, and known instrument panels include edges with acute corners providing for tight fits and fine lines. Various technologies for the manufacture of instrument panel skin layers are known. However, such known technologies are not capable of producing cantilevered features. By utilizing reaction injection molding (RIM), molded ribs may be formed which can act as foam dams and permit cantilevered skin portions or features. Reaction injection molding (RIM) is a processing technique for the formation of polymer parts by direct polymerization in a mold through a mixing activated reaction. The RIM process uses thermoset polymers such as polyurethane or other suitable thermoset polymers. A RIM manufactured skin layer may have an exterior configured to the visible portion of the instrument panel and may have an interior having a foam layer attached thereto. Known RIM manufactured skin layers are generally curved to match the desired curvatures of an adjacently disposed automotive interior component. Further, the known RIM manufactured skin layers may include edges with acute angles. The process of forming known RIM manufactured skin layers having both a curvature and acute angles often requires complicated or multiple die press actions, thereby adding to the complexity and cost of the manufacturing process. Further, during the RIM process of manufacturing a known RIM manufactured skin layer, formation of one or more acute angles in combination with the curvature may result in the formation of extraneous flashes of skin material due to the core action to hollow a corner. For purposes of this application, an extraneous flash of skin material is defined as the RIM material that leaks between a cavity and a core along a parting line seal. Parting line seals are not 100% efficient in the case of low viscosity materials such as injected RIM. The leaked RIM produces an unintended film attached to the skin at the parting line. Core action may involve collapsible cores that are configured to change from an expanded condition to mold an article on the core, to a collapsed condition that allows the article to be removed from the core. Collapsible cores are devices that become smaller during the RIM process. The extraneous flashes of skin material may be disruptions to any foam or similar substance disposed on the underside portion of the skin layer. If the foam layer is disrupted, the skin layer may have soft unsupported areas due to “voids” in the foam, such as urethane foam, or may have a non-uniform visual appearance.

For example, FIG. 1 is an illustration of a cross-sectional view of a related art multi-layer automotive interior component 100 comprised of a skin layer 108, a substrate 110, and a urethane foam layer 112. As shown in FIG. 1, the related art multi-layer automotive interior component 100 further comprises a skin edge 102 having a substantially acute angle 104. Further, the related art multi-layer automotive interior component 100 comprises extraneous flash material 106. The extraneous flash material 106 is typically caused by the die action required for forming the acute angle 104. Namely, the die action to form the acute angle 104 is generally separate from the die action for forming the remainder of the skin edge 102 of the multi-layer automotive interior component 100, thus causing the area between the two die actions to result in extraneous flash material 106. For example, in order to form acute angle 104 in the skin edge 102, a core 204 with a moving core slide 212, as shown in FIG. 5, forms the reverse side of a skin layer 208, while a mold cavity 206 forms an “A” side or visible portion of the skin layer 208 in a RIM molded automotive skin 200. Once the skin layer 108 and the injection molded substrate 110 are formed, urethane foam is injected between the skin layer 108 and the injection molded substrate 110 to form the urethane foam layer 112 and to produce the multi-layer automotive interior component 100. Extraneous flash material 210 may thus be formed between the core 204 and the core slide 212, and may cause disruptions in the flow of the urethane foam layer 112 and may further cause undesirable formation of a non-smooth/non-uniform foam layer.

As a further example, FIG. 5 is an illustration of a cross-sectional view of a related art RIM molded automotive skin 200. FIG. 5 shows a RIM mold 202 in a closed position. The RIM mold 202 comprises RIM mold halves, the core 204, the mold cavity 206, the skin layer 208, extraneous flash material 210, and the core slide 212 in an extended position. When the RIM mold 202 is closed with the core slide 212 extended, the RIM mold 202 is injected to fill the mold cavity 206. In preparation for opening of the RIM mold 202, the core slide 212 is retracted in direction A1 to eliminate undercuts on the RIM molded automotive skin 200 in preparation for opening of the RIM mold 202. When the RIM mold 202 is opened, the skin layer 208 may be removed. The core action required for forming the skin layer 208 in the related art may require multiple cores or multiple core slide actions, and may leave extraneous flash material 210 on the underside portion of the skin layer 208 (also shown in FIG. 1 as extraneous flash material 106 on skin layer 108).

It would therefore be of benefit to provide an automotive interior component with a cantilevered skin portion that provides advantages over known components and manufacturing methods.

### SUMMARY

The invention overcomes the drawbacks and deficiencies of the aforementioned known multi-layer automotive interior components and manufacturing methods by providing a multi-layer automotive interior component, such as an instrument panel, door trims, center consoles, or another suitable component, with a foam dam and a cantilevered skin portion. In an embodiment of the invention, the cantilevered skin portion may provide for the integration of hidden light sources and/or similar blind (not visible) features. The invention overcomes the drawbacks and deficiencies of the aforementioned multi-layer automotive interior components by further providing a method of manufacturing a multi-layer automotive interior component with a foam dam and a cantilevered skin portion, and further providing a method of manufacturing a multi-layer automotive interior component with a cantilevered skin portion for integrating hidden light sources and/or similar blind (not visible) features. The invention further provides a multi-layer automotive interior component, such as an automotive instrument panel, having a cantilevered skin portion that eliminates or minimizes extraneous flash material of skin in foam flow areas, thereby providing for improved foam flow, a substantially uniform foam layer, and a simplified and less costly reaction injection molding (RIM) tool action. The invention further provides a multi-layer automotive interior component, such as an automotive instrument panel, having a cantilevered skin portion that has a skin layer with a uniform visual appearance, that has a foam layer that is smooth and uniform and does not have soft unsupported areas due to voids in the foam, and that does not require multiple cores or multiple core slide actions to make.

In one of the advantageous embodiments of the invention, there is provided a multi-layer automotive interior component. The multi-layer automotive interior component comprises a skin layer having an exterior portion and an underside portion, where the exterior portion is visible. The multi-layer automotive interior component further comprises a foam dam formed on the underside portion of the skin layer, a cantilevered skin portion extending from the foam dam, a substrate disposed opposite the underside portion of the skin layer, and a foam layer between the substrate and the underside portion of the skin layer. The foam layer is limited by the foam dam, and the foam layer is substantially uniform.

In another one of the advantageous embodiments of the invention, there is provided an automotive instrument panel. The automotive instrument panel comprises a skin layer having a first side, a second side, and an edge. The first side is visible, the second side is substantially free of an extraneous flash material, and the edge is configured to align with another different automotive interior component. The automotive instrument panel further comprises a substantially uniform foam layer disposed adjacent the second side. The automotive instrument panel further comprises a foam dam formed on an underside portion of the first side of the skin layer near the edge, wherein the foam dam limits the foam layer. The automotive instrument panel farther comprises a cantilevered skin portion extending from the foam dam, wherein the cantilevered skin portion is not in contact with the foam layer.

In another one of the advantageous embodiments of the invention, there is provided a method of making a multi-layer automotive interior component. The method comprises the step of manufacturing a skin layer having a foam dam and a cantilevered skin portion. The method further comprises the step of positioning the skin layer adjacent a substrate. The method further comprises the step of injecting a foam layer between the skin layer and the substrate. The foam layer flows substantially free of disruption between the substrate and the skin layer, and the foam layer is limited by the foam dam. The foam layer then hardens and fixedly joins the skin layer to the substrate.

In another one of the advantageous embodiments of the invention, there is provided a method of making an automotive instrument panel. The method comprises the steps of manufacturing a skin layer having a first side, a second side, an edge, a foam dam, and a cantilevered skin portion. The first side is visible, the second side is substantially free of an extraneous flash material, and the edge is configured to align with a different automotive interior component distinct from the automotive instrument panel. The method further comprises the step of positioning the skin layer adjacent a substrate. The method further comprises the step of injecting a foam layer between the skin layer and the substrate. The foam layer flows substantially free of disruption between the substrate and the skin layer, and the foam layer is limited by the foam dam. The foam layer then hardens and fixedly joins the skin layer to the substrate.

Additional features, advantages, and embodiments of the invention may be set forth or become apparent from consideration of the following detailed description, drawings, and claims. Moreover, it is to be understood that both the foregoing summary of the invention and the following detailed description are exemplary and intended to provide explanation without limiting the scope of the invention as claimed.

### BRIEF DESCRIPTION OF THE DRAWINGS

The disclosure can be better understood with reference to the following detailed description taken in conjunction with the accompanying drawings which illustrate preferred and exemplary embodiments, but which are not necessarily drawn to scale, wherein:

FIG. 1 is an illustration of a cross-sectional view of a related art multi-layer automotive interior component;

FIG. 2 is an illustration of a cross-sectional view of one of the embodiments of a multi-layer automotive interior component according to the invention;

FIG. 3 is an illustration of a cross-sectional view of another one of the embodiments of a multi-layer automotive interior component according to the invention;

FIG. 4 is an illustration of an automotive instrument panel having one of the embodiments of a multi-layer automotive interior component according to the invention;

FIG. 5 is an illustration of a cross-sectional view of a related art RIM molded automotive skin;

FIG. 6 is an illustration of a cross-sectional view of one of the embodiments of a RIM mold making a multi-layer automotive interior component in a closed position according to the invention;

FIG. 7 is an illustration of a cross-sectional view of the RIM mold making a multi-layer automotive interior component of FIG. 6 in an open position;

FIG. 8 is an illustration of a flow diagram of one of the embodiments of the method of manufacturing a multi-layer automotive interior component according to the invention; and,

FIG. 9 is an illustration of a flow diagram of one of the embodiments of the method of manufacturing a multi-layer automotive instrument panel having another automotive interior component according to the invention.

### DETAILED DESCRIPTION

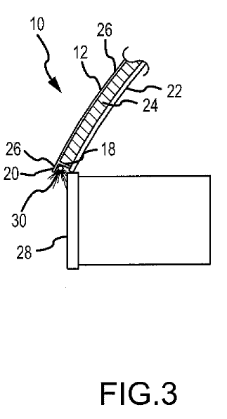

Referring now to the drawings wherein like reference numerals designate corresponding parts throughout the several views, FIGS. 2 and 3 illustrate embodiments of a multi-layer automotive interior component 10 having a foam dam 18 and a cantilevered skin portion 20 according to the invention. The method of the disclosed embodiments may be used for making multi-layer automotive interior components in instrument panels, door trims, center consoles, or other suitable components, for use in automotive vehicles, trucks, and other suitable vehicles. Accordingly, one of ordinary skill in the art will recognize and appreciate that the method of the disclosure can be used in any number of applications involving the manufacture of multi-layer automotive interior components.

FIG. 2 is an illustration of a cross-sectional view of one of the embodiments of a multi-layer automotive interior component 10 according to the invention. The multi-layer automotive interior component 10 may be made by a reaction injection molding (RIM) process or another suitable manufacturing process. As shown in FIG. 2, multi-layer automotive interior component 10 comprises a skin layer 12 having an exterior portion 14 and an underside portion 16. The exterior portion 14 may be configured to be a visible component of the multi-layer automotive interior component 10. The skin layer 12 may be composed of a RIM polyurethane and/or similar suitable material. The skin layer 12 of the multi-layer automotive interior component 10 may be manufactured by a reaction injection molding (RIM) process. However, the skin layer 12 of the multi-layer automotive interior component 10 may also be manufactured by other suitable manufacturing processes. The multi-layer automotive interior component 10 further comprises a foam dam 18 formed on the underside portion 16 of the skin layer 12. The skin layer 12 of the multi-layer automotive interior component 10 may be configured to include the foam dam 18. The foam dam 18 is a portion of the skin layer 12. The multi-layer automotive interior component 10 further comprises a cantilevered skin portion 20 or feature extending from a portion of the foam dam 18 and extending from the skin layer 12. Preferably, the cantilevered skin portion 20 forms an angle of between about 30 degrees and about 120 degrees with the foam dam 18. More preferably, the cantilevered skin portion 20 forms an angle of between about 30 degrees and about 90 degrees with the foam dam 18. The multi-layer automotive interior component 10 may further comprise a substrate 22 disposed opposite the underside portion 16 of the skin layer 12. The substrate 22 may be coupled to or adjacent to a portion of the foam dam 18. The substrate 22 may be comprised of polypropylene blends, polycarbonate, or other suitable thermoplastic materials. The skin layer 12 preferably covers the substrate 22 and extends to the substrate edges, including the foam dam 18. The skin layer 12 preferably has a substantially constant thickness but may thicken up to 2.5 times its size through the foam dam 18 feature. Preferably, the skin layer 12 is flexible and the substrate 22 is rigid. The multi-layer automotive interior component 10 further comprises a foam layer 24 between the substrate 22 and the underside portion 16 of the skin layer 12. The foam layer 24 is limited by the foam dam 18, and the foam layer 24 is substantially smooth and uniform in appearance. The foam dam 18 may act to limit the flow of foam, and thereby define the cantilevered skin portion 20 under which there is no foam layer 24 or substrate 22. Preferably, the cantilevered skin portion 20 is not in contact with the foam layer 24. The foam layer 24 may be provided between the underside portion 16 of the skin layer 12, and the substrate 22 and may be formed by injection of a substantially liquid foam substance which fills the cavity between the skin layer 12 and the substrate 22 and solidifies or hardens into the foam layer 24. The foam layer may comprise a structurally engineered foam, such as urethane foam or another suitable foam, that is normally rigid in order to be resistant and withstand compressive forces under a predetermined amount of force and to provide structural strength to the molding. The foam layer 24 may provide a substantially uniform support layer between the substrate 22 and the underside portion 16 of the flexible skin layer 12. The foam layer 24 may be limited in its movement by the foam dam 18 during formation thereof. The multi-layer automotive interior component 10 may further comprise a light source 30 (see FIG. 3) coupled to the cantilevered skin portion 20 or coupled to the foam dam 18.

FIG. 3 is an illustration of a cross-sectional view of another one of the embodiments of the multi-layer automotive interior component 10 according to the invention. As shown in FIG. 3, the multi-layer automotive interior component 10 may include edge 26 with the cantilevered skin portion 20. The edge 26 is generally the overhang of the cantilevered skin portion 20. The edge 26 may be configured to align with a second and different automotive interior component 28. The second automotive interior component 28 may comprise a center console, a radio console, or another suitable automotive interior component. The foam dam 18 may be located substantially near the edge 26 of the instrument panel close to the second automotive interior component 28 (see FIG. 3). Preferably, the edge 26 is not in contact with the foam layer 24. The foam dam 18 and/or the cantilevered skin portion 20 may integrate a light source 30, which may be configured to project light upon the second automotive interior component 28, while being hidden from view by the cantilevered skin portion 20. Those skilled in the art can appreciate that other blind (not visible) design features may be located below or behind the cantilevered skin portion 20. In this embodiment of the invention, the cantilevered skin portion 20 may be utilized to integrate the light sources 30 and/or similar blind (not visible) features. By placing the blind (not visible) feature between the foam dam 18 and cantilevered skin portion 20, the feature may be hidden from visibility and may provide additional aesthetic appeal to the automotive interior. Thus, the instrument panel according to the invention may include a hidden light source, and/or a similar blind (not visible) feature, for enhancing the aesthetic appeal of the automotive interior.

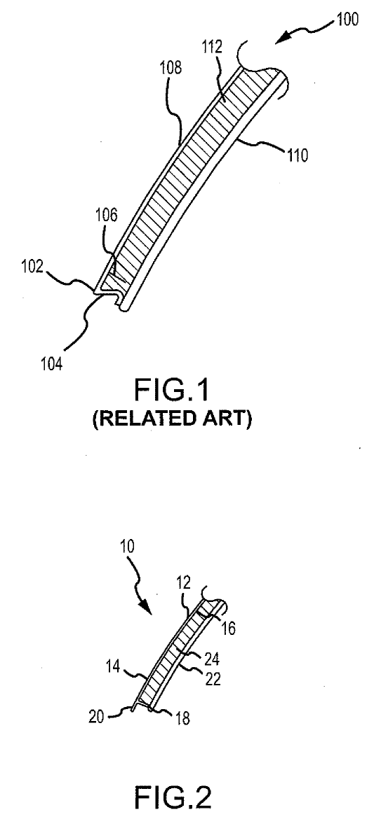

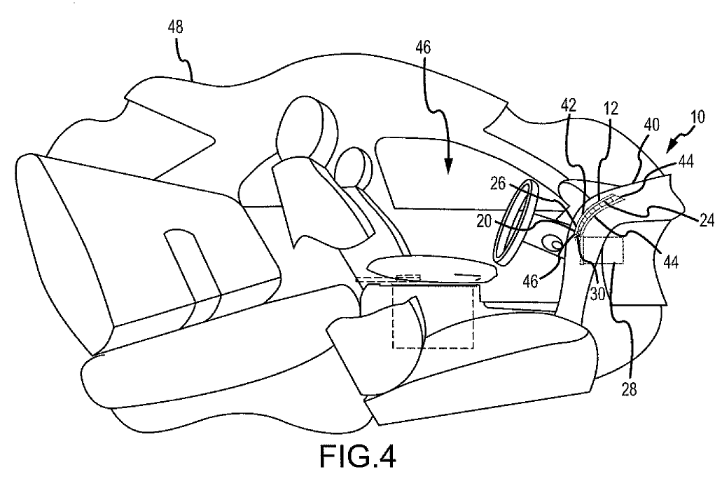

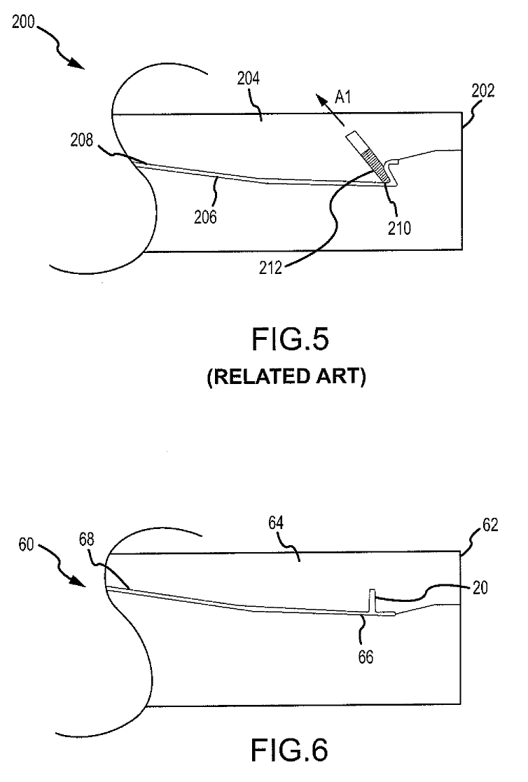

FIG. 4 is an illustration of an automotive instrument panel 40 having one of the embodiments of a multi-layer automotive interior component 10 according to the invention. FIG. 4 shows an automotive instrument panel 40 comprising a skin layer 12 having a first side 42, a second side 44, and an edge 26. The first side 42 may be visible from an interior 46 of an automotive vehicle 48. The second side 44 is preferably not visible and completely or substantially free of an extraneous flash material 106 (see FIG. 1). The edge 26 may be configured to align with another different automotive interior component 28. The automotive interior component 28 may comprise a radio console, an instrument panel console, or another suitable automotive interior component. The automotive instrument panel 40 further comprises a substantially uniform foam layer 24 disposed adjacent the second side 44. The automotive instrument panel 40 further comprises a foam dam 18 (see also FIG. 3). The foam dam 18 may be substantially perpendicular to the edge 26. The foam dam 18 may be within 35 millimeters of the edge 26 of the skin layer 12. The foam dam 18 protrudes and is preferably formed on the second side 44 of the skin layer 12 near the edge 26. The foam dam 18 limits or stops the foam layer 24. The automotive instrument panel 40 further comprises a cantilevered skin portion 20 extending from the foam dam 18 (see also FIG. 3). Preferably, the cantilevered skin portion 20 is not in contact with the foam layer 24. The automotive instrument panel 40 may further comprise a light source 30 adjacent the cantilevered skin portion 20 and/or adjacent the foam dam 18 (see also FIG. 3) The light source 30 may be below the first side 42 of the skin layer 12 and may provide light to the automotive interior component 28. Preferably, the foam layer 24 is completely or substantially free of disruption from the extraneous flash material 106 (see FIG. 1 and see FIG. 5 reference number 210) that may form on the second side 44 of the skin layer 12.

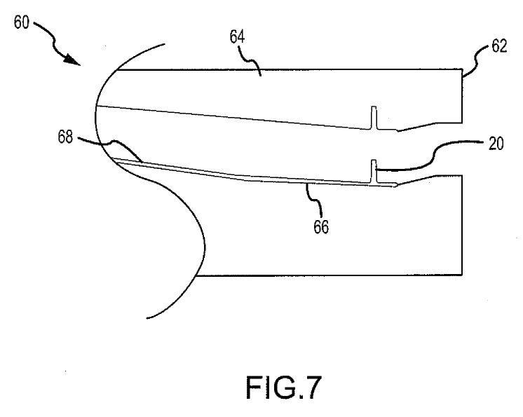

FIG. 6 is an illustration of a cross-sectional view of one of the embodiments of a RIM mold making a multi-layer automotive interior component 60 with the cantilevered skin portion 20 in a closed position according to the invention. FIG. 6 shows a RIM mold 62 in a closed position. The RIM mold 62 comprises a RIM mold core 64, a RIM mold cavity 66, and a skin layer 68. When the RIM mold 62 is closed, the RIM mold 62 is injected to fill the RIM mold cavity 66. This embodiment may not use core slide 212 action or core 204 (see FIG. 5). FIG. 7 is an illustration of a cross-sectional view of the RIM mold making the multi-layer automotive interior component 60 with the cantilevered skin portion 20 of FIG. 6 in an open position. When the RIM mold 62 is opened, the skin layer 68 of the multi-layer automotive interior component 60 may be removed. In the RIM molded multi-layer automotive interior component 60 of this embodiment, no extraneous flash material 106 (see FIG. 1 and see FIG. 5 reference number 210) is created.

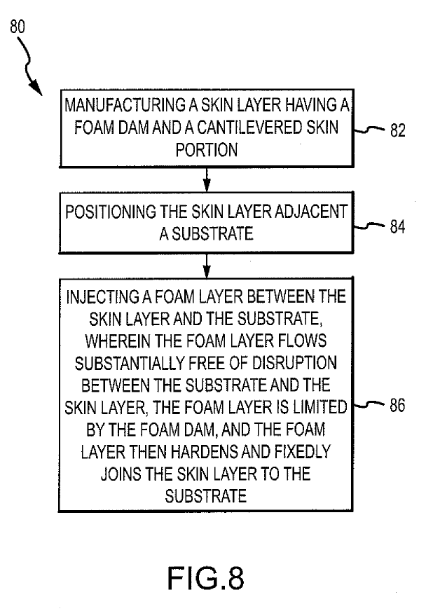

FIG. 8 is an illustration of a flow diagram of one of the embodiments of a method 80 of manufacturing a multi-layer automotive interior component 10 according to the invention. The method 80 comprises step 82 of manufacturing a skin layer 12 (see FIG. 2) having a foam dam 18 (see FIG. 2) and a cantilevered skin portion 20 (see FIG. 2). The manufacturing step 82 preferably comprises a reaction injection molding process. However, other suitable manufacturing processes may be used. The method 80 further comprises step 84 of positioning the skin layer 12 adjacent a substrate 22 (see FIG. 2). The method 80 further comprises step 86 of injecting a foam layer 24 between the skin layer 12 and the substrate 22 (see FIG. 2). The foam layer 24 flows substantially free of disruption between the substrate 22 and the skin layer 12. The foam layer 24 is limited by the foam dam 18. The foam layer 24 then hardens and fixedly joins the skin layer 12 to the substrate 22. In order to manufacture multi-layer automotive interior component 10, the overall method may generally include manufacturing the skin layer 12 having the foam dam 18 and the cantilevered skin portion 20, positioning the skin layer 12 adjacent the substrate 22, and injecting the foam layer 24 therebetween. After being injected, foam (not shown) in the foam layer 24 may flow substantially free of disruption between the substrate 22 and the skin layer 12, while being limited by the foam dam 18. The specific method of forming the multi-layer automotive interior component 10 may include reaction injection molding (RIM) the skin layer 12 formed by various embodiments of the method of the invention. In one of the embodiments of the method, the reaction injection molding may comprise using a RIM mold with a core and a mold cavity for forming the skin layer 12 and foam dam 18. The foam dam 18 which matches the die draw angle (with a few degrees of draft) eliminates the need for a core slide, and as a result, does not produce any extraneous flash material 106 (see FIG. 1) on the underside portion 16 of the skin layer 12. The cavity may be of a complementary shape to the foam dam 18, to thus form the skin layer 12 including the foam dam 18 using a single core action. Thus, for embodiments of the method of forming the skin layer 12, any extraneous flash material 106 (see FIG. 1) is eliminated or substantially minimized, thus providing disruption free flow of the foam layer 24. In another embodiment, the reaction injection molding may comprise using a first core being either rotatable or slidable for forming a first side of the foam dam, and a second core being slidable for forming a second side of the foam dam and an underside portion of the skin layer.

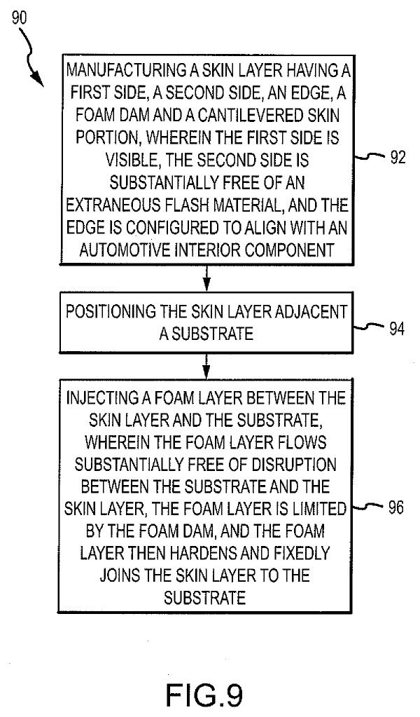

FIG. 9 is an illustration of a flow diagram of one of the embodiments of a method 90 of manufacturing an automotive instrument panel 40 having a multi-layer automotive interior component 10 according to the invention. The method 90 comprises the step 92 of manufacturing a skin layer 12 having a first side 42, a second side 44, an edge 26, a foam dam 18, and a cantilevered skin portion 20 (see FIG. 4). The first side 42 is visible, the second side 44 is substantially free of an extraneous flash material, and the edge 26 is configured to align with another different automotive interior component 28 (see FIG. 4) such as a radio console or instrument panel console. The method 90 further comprises step 94 of positioning the skin layer 12 adjacent a substrate 22. The method 90 further comprises step 96 of injecting a foam layer 24 between the skin layer 12 and the substrate 22. The foam layer 24 flows substantially free of disruption between the substrate 22 and the skin layer 12, and the foam layer 24 is limited by the foam dam 18. The foam layer 24 then hardens and fixedly joins the skin layer 12 to the substrate 22. The cantilevered skin portion 20 may be coupled to a light source 30 (see FIG. 4). Alternatively, the foam dam 18 may be coupled to a light source 30. The automotive instrument panel 40 may include the integration of the light source 30 in the cantilevered skin portion 20 of the skin layer 12.

For the embodiments of the method, the skin layer 12 of the automotive instrument panel may be manufactured using the RIM process. The RIM process may include molding plastic parts using liquid monomers, such as polyurethanes or foamed polyurethanes, or other suitable materials, pumping the monomers into a mix head which combines the monomers under high pressure with isocyanate to initiate the hardening reaction. During this process, the mixture may fill the mold cavity under low pressure, and the monomers may polymerize into a solid mass by energy supplied by a chemical reaction. The mold cavity into which the mixture flows and rests defines the visible portion of the skin layer. Subsequently, a core or a core with core slide, may move substantially perpendicular to the cavity to form the underside portion of the skin layer. The invention provides a skin layer 12 having a foam dam 18, which is formed by a simplified core action, and which further defines a cantilevered skin portion 20. For the embodiments of the method, the substrate 22 may be provided adjacent the underside portion 16 of the skin layer 12 in a foam tool (not shown), and the foam layer 24 may be injected therebetween. The injected foam layer 24 may flow in the area between the substrate 22, the underside portion 16 of the skin layer 12 and the foam dam 18, substantially free of disruption from any extraneous flash material. In the related art skin layer (see FIGS. 1 and 5), the extraneous flash material 106 (see FIG. 1) and extraneous flash material 210 (see FIG. 5) can disrupt the flow of foam and cause the foam layer 24 to be undesirably non-uniform and not smooth.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A multi-layer automotive interior component comprising:
a skin layer having an exterior portion and an underside portion, the exterior portion being visible;
a foam dam formed on the underside portion of the skin layer;
a cantilevered skin portion extending from the foam dam;
a substrate disposed opposite the underside portion of the skin layer; and,
a foam layer between the substrate and the underside portion of the skin layer, wherein the foam layer is limited by the foam dam, and further wherein the foam layer is substantially uniform.

2. The multi-layer automotive interior component of claim 1, further comprising a light source coupled to the cantilevered skin portion.

3. The multi-layer automotive interior component of claim 1, further comprising a light source coupled to the foam dam.

4. The multi-layer automotive interior component of claim 1, wherein the multi-layer automotive interior component is made by a reaction injection molding (RIM) process.

5. The multi-layer automotive interior component of claim 1, wherein the cantilevered skin portion is not in contact with the foam layer.

6. The multi-layer automotive interior component of claim 1, wherein the cantilevered skin portion forms an angle of between about 30 degrees to about 120 degrees with the foam dam.

7. An automotive instrument panel comprising:
a skin layer having a first side, a second side, and an edge, the first side being visible, the second side being substantially free of an extraneous flash material, and the edge being configured to align with a different automotive interior component;
a substantially uniform foam layer disposed adjacent the second side;
a foam dam formed on the second side of the skin layer near the edge, wherein the foam dam limits the foam layer; and,
a cantilevered skin portion extending from the foam dam, wherein the cantilevered skin portion is not in contact with the foam layer.

8. The automotive instrument panel of claim 7, further comprising a light source adjacent the cantilevered skin portion, wherein the light source is below the first side of the skin layer and provides light to the automotive interior component.

9. The automotive instrument panel of claim 7, further comprising a light source adjacent the foam dam, wherein the light source is below the first side of the skin layer and provides light to the automotive interior component.

10. The automotive instrument panel of claim 7, wherein the foam layer is substantially free of disruption from the extraneous flash material on the second side of the skin layer.

11. A method of making a multi-layer automotive interior component comprising:
manufacturing a skin layer having a foam dam and a cantilevered skin portion;
positioning the skin layer adjacent a substrate;
injecting a foam layer between the skin layer and the substrate, wherein the foam layer flows substantially free of disruption between the substrate and the skin layer and the foam layer is limited by the foam dam, and wherein the foam layer then hardens and fixedly joins the skin layer to the substrate.

12. The method of claim 11, wherein the manufacturing step comprises reaction injection molding.

13. The method of claim 12, wherein the reaction injection molding comprises using a core for forming the skin layer, the core having a complementary cavity for forming the foam dam.

14. The method of claim 13, wherein use of the core does not produce an extraneous flash material on an underside portion of the skin layer.

15. The method of claim 12, wherein the reaction injection molding comprises using a first core being either rotatable or slidable for forming a first side of the foam dam, and a second core being slidable for forming a second side of the foam dam and an underside portion of the skin layer.

16. The method of claim 11, wherein the cantilevered skin portion is coupled to a light source.

17. The method of claim 11, wherein the foam dam is coupled to a light source.

18. A method of making an automotive instrument panel comprising:
manufacturing a skin layer having a first side, a second side, an edge, a foam dam, and a cantilevered skin portion, wherein the first side is visible, the second side is substantially free of an extraneous flash material, and the edge is configured to align with a different automotive interior component;
positioning the skin layer adjacent a substrate; and,
injecting a foam layer between the skin layer and the substrate, wherein the foam layer flows substantially free of disruption between the substrate and the skin layer and the foam layer is limited by the foam dam, and wherein the foam layer then hardens and fixedly joins the skin layer to the substrate.

19. The method of claim 18, wherein the cantilevered skin portion is coupled to a light source.

20. The method of claim 18, wherein the foam dam is coupled to a light source.
